(19) United States
(12) Patent Application Publication
(10) Pub. No.: US 2003/0006618 A1
(43) Pub. Date: Jan. 9, 2003

(54) Latch assembly and method of operating such an assembly

(76) Inventor: Gurbinder Singh Kalsi, West Midlands (GB)

Correspondence Address: CARLSON, GASKEY & OLDS, P.C., 400 WEST MAPLE ROAD, SUITE 350, BIRMINGHAM, MI, 48009, US

(21) Appl. No.: 10/165,175

(22) Filed: Jun. 7, 2002

Related U.S. Application Data
(63) Continuation-in-part of application No. 09/674,870, filed on Dec. 18, 2000.
Application No. 09/674,870 is a 371 of international application No. PCT/GB99/01411, filed on May 6, 1999.

(30) Foreign Application Priority Data
May 6, 1998 (GB) 9809640.7

(51) Int. Cl. E05C 3/06

(52) U.S. Cl. 292/201

(57) ABSTRACT

An assembly comprising a latch mechanism operably connected to a controller, the mechanism having first and second operating modes with each mode having alternate states, the controller being programmed such that said second operating modes is not capable of use.

This application is a continuation-in-part of U.S. Nonprovisional patent application Ser. No. 09/674,870, filed on Nov. 6, 2000, which claims priority to PCT applications PCT /GB99/01411, filed May 6, 1999, which itself claims priority to British application GB9809640.7, filed May 6,1998.

### BACKGROUND OF THE INVENTION

The present invention relates to latch assemblies for doors of vehicles and to a method of operating such an assembly.

It is known to provide latch mechanisms on doors of vehicles to allow opening and closing of the door. Such latch mechanisms have various modes of operation, e.g.:

a) Lock mode, wherein operation of an outside door handle does not open the latch mechanism;

b) Superlocked mode, when in operation of an outside or an inside release lever does not operate the latch mechanism;

c) Child safety mode, wherein operation of an inside release lever does not open the latch mechanism, whether or not the latch mechanism is locked; and

d) Release mode, wherein the latch mechanism is released via means other than 20 operation of the inside or outside release levers.

Each mode has alternate states, e.g., locked/unlocked, superlocked/not superlocked, child safety on/off and release/not released.

Typically, each mode requires an individual mechanism to effect the alternative states, with operation of each mechanism being effected either manually or with an individual power actuator.

In the case of a latch mechanism operated entirely by power actuators, such as DC motors, it is also necessary to be able to open a locked door which has the child safety feature on in an emergency situation when actuation of the power actuators is not possible, such as when the keys to the vehicle are not available.

### SUMMARY OF THE INVENTION

According to an aspect of the present invention there is provided an assembly comprising a latch mechanism operably connected to a controller, the mechanism having first and second operating modes with each mode having alternate states, the controller being programmed such that said second operating mode is not capable of use.

A second aspect of the present invention provides a method of controlling a latch having first and second operating modes with each mode having alternate states, the method comprising the step of controlling the latch such that the second operating mode is not capable of use.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a latch mechanism forming part of a latch assembly according to an embodiment of the present invention in a super-locked condition.

FIG. 1A is an enlarged view of part of FIG. 1.

FIG. 1B is a schematic view in the direction of arrow A of FIG. 1.

FIG. 2 is the latch mechanism of FIG. 1 in a locked position with child safety on.

FIG. 3 is the latch mechanism of FIG. 1 in an unlocked condition with the child safety on.

FIG. 4 is the latch mechanism of FIG. 1 in a locked condition with the child safety off.

FIG. 5 is the latch mechanism of FIG. 1 in an unlocked position with the child safety off.

FIG. 6 is a latch mechanism of FIG. 1 in a release position.

FIG. 7 is a schematic plan view of a vehicle incorporating a latch assembly according to an embodiment of the present invention.

FIG. 8 is a schematic plan view of a vehicle incorporating a latch assembly according to another embodiment of the present invention.

### DETAILED DESCRIPTION OF THE PREFERRED EMBODIMENT

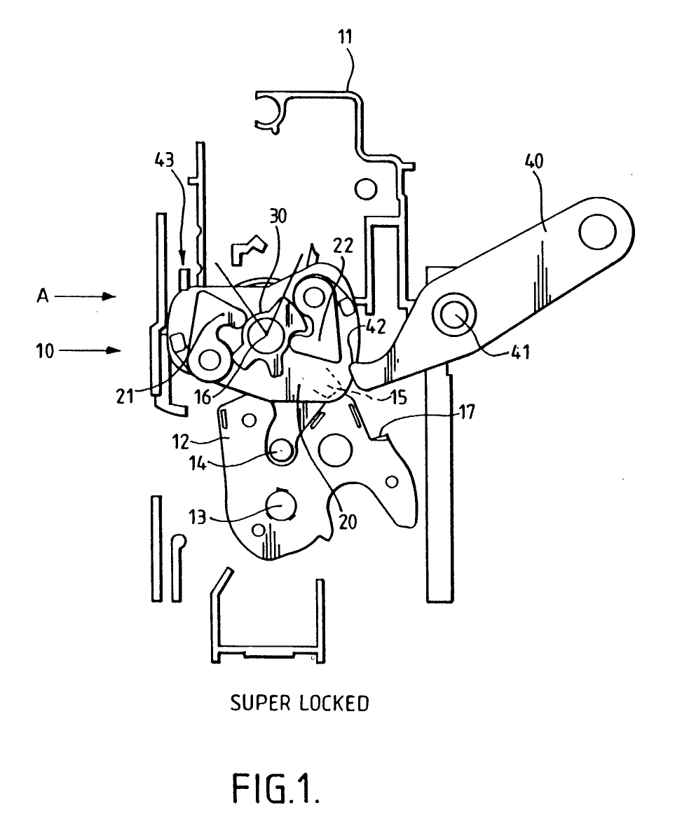

With reference to FIGS. 1 to 6 there is a latch mechanism 10 including a body 11 which supports various components of the latch mechanism 10 as indicated below.

Latch mechanism 10 further includes a claw 12 pivotally mounted about axis 13 on the body 11. Claw 12 acts to secure an associated door (not shown) in a closed position via a striker pin 14 attached to the door aperture. Rotation of the claw 12 in an anticlockwise direction about axis 13 when viewing FIG. 1 allows release of the striker pin 14, thus enabling opening of the associated door.

The claw 12 is held in a closed position by a pawl 15, only part of which is shown in dotted profile in FIG. 1 for clarity. Pawl 15 is pivotally mounted on body 11 and can rotate about axis 16. Claw 12 can be held in a first safety position (not shown) when pawl 15 engages first safety abutment 17.

Pawl lifter 20 is generally flat and lies in a plane parallel to pawl 15, to which it is rotationally secured. When viewing FIG. 1 pawl 15 is obscured by pawl lifter 20. Clearly, pawl lifter 20 also rotates about axis 16.

Inside lock link 21 and outside lock link 22 are mounted for movement with the pawl, in this case they are each individually pivoted about respective axes 21a and 22a on pawl lifter 20. In this case inside lock link 21 and outside lock link 22 are identical and each have respective cam followers 21b and 22b and release abutments 21c and 22c. Inside lock link 21 and outside lock link 22 are each biased in a clockwise direction when viewing FIG. 1 such that the respective cam followers 21b and 22b contact cam 30.

Cam 30 is capable of rotating independently from pawl lifter 20 about axis 16. Cam 30 has three lobes 31, 32, and 33 and two levers 34 and 35 shown diagrammatically for clarity. Lobes 31, 32, 33 and levers 34 and 35 are all rotationally fast with cam 30.

Preferably cam 30 can at least be rotated to the various positions as described below by a power actuator (not shown) such as a DC motor or preferably a stepper motor.

Outside release lever 40 is pivotally mounted about axis 41. Inside release lever 43 5 (shown diagrammatically in FIG. 1b) is pivotally mounted about axis 44.

Operation of a door latch mechanism is as follows.

FIG. 1 shows the door latch mechanism in a super lock condition, that is to say operation of the outside release lever 40 or inside release lever 43 does not allow unlatching of the mechanism. In particular it can be seen that if outside release lever 40 were to be operated by being rotated in a clockwise direction about axis 41, abutment 42 would pass release abutment 22c of outside lock link without contact (note that outside release lever 40 is in the same plane as outside lock link 22). Similarly inside release lever 43 when operated by being rotated in an anticlockwise direction about axis 44 when viewing FIG. 1b, would cause abutment 45 to pass release abutment 21c of inside lock link 21 (see especially FIG. 1).

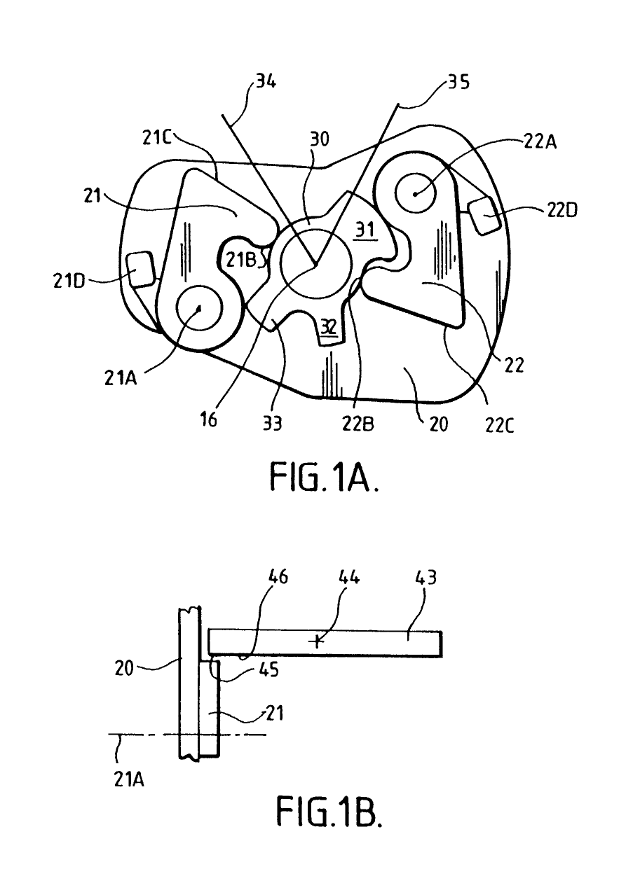

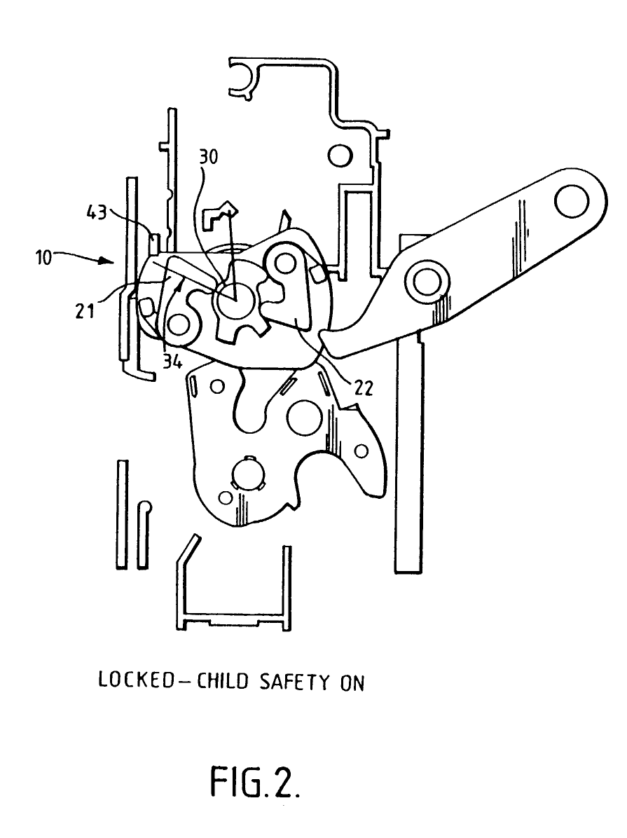

FIG. 2 shows the door latch mechanism 10 in a locked position with the child safety feature on. It will be noted that cam 30 has been rotated 30 degrees in an anticlockwise direction when compared to FIG. 1. However, the inside lock link 21 and outside lock link 22 are in the same position when compared with FIG. 1 since neither of the cam followers 21b or 22b have, at this stage, ridden up any of the lobes 31, 32 or 33 or the cam 30. However, lever 34 has been rotated to a position whereby operation of the inside release lever 43 in an anticlockwise direction when viewing FIG. 1b would cause abutment 46 to contact lever 34 and rotate cam 30 to the position shown in FIG. 3. Note this initial operation of inside release lever 43 does not unlatch the mechanism but only operates to unlock the door (see below). This method of being able to override and open a locked door which has the child safety on is especially important in an emergency situation whereby a passer-by can effect access to the inside door handle (e.g., by breaking the door window glass), operate the inside door handle to unlock the door, then operate the outside door handle to open the door and then remove the child from the car.

FIG. 3 shows the door latch mechanism 10 in an unlocked condition with the child safety feature on. In this case the cam 30 has been rotated sufficiently (either by operating the inside release lever when the cam was in the position shown in FIG. 2 or by independent rotation of the cam directly e.g., by a power actuator) such that cam follower 22b has ridden up cam lobe 32 resulting in anticlockwise rotation of outside lock link 22. Thus when outside release lever 40 is operated, abutment 42 contact release abutment 22c causing the pawl lifter 20 as a whole to rotate anticlockwise when viewing FIG. 3 and releasing the pawl 15 and allowing the claw 12 to open. Stop 22d limits the anticlockwise rotation of outside lock link 22. Upon release of the outside release lever 40 the pawl lifter 20 is biased back to the position as shown in FIG. 3 by a spring (not shown). It should also be noted that the inside lock link 21 is in the same position as that shown in FIG. 1, thus operation of the inside release lever 43 does not allow opening of the door.

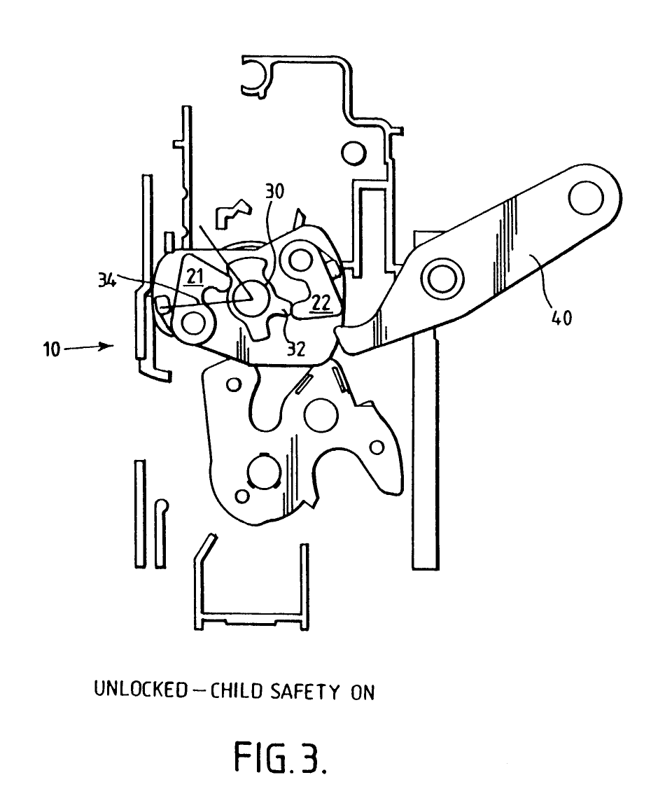

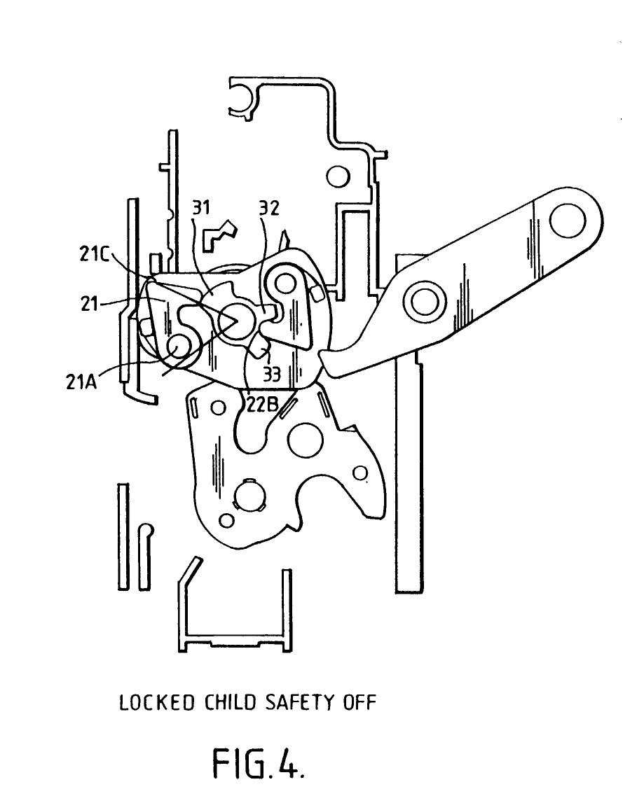

FIG. 4 shows the door latch mechanism 10 in a locked condition with the child safety feature off. It should be noted that the cam 30 has been rotated 90 degrees in an anticlockwise direction when compared with FIG. 1. This results in cam follower 22b being situated between lobes 32 and 33 thus ensuring that operation of outside release lever 40 does not release the latch mechanism. Furthermore, the rotation of the cam 30 has caused cam follower 21b to ride up cam lobe 31 causing inside lock link 21 to rotate anticlockwise about axis 21a. Thus abutment 21c of inside lock link 21 is contacted by abutment 45 of inside release lever 43 when it is operated. This causes anticlockwise rotation of the pawl lifter 20 about axis 16 resulting in unlatching of the door mechanism and allowing the door to be subsequently opened. Stop 21d limits the anticlockwise rotation of inside lock link 21. It should be noted that the operation of the inside release lever 43 also causes abutment 46 to contact lever 35 causing rotation of cam 30 to the position shown in FIG. 5. This prevents a vehicle occupant inadvertently locking himself out of the vehicle since opening of the door from the inside automatically unlocks the door, allowing subsequent opening from the outside.

FIG. 5 shows the door latch mechanism 10 in an unlocked position with the child safety feature off. It can be seen that the cam has been rotated (either by operating the inside release lever when the cam was in the position shown in FIG. 4 or by independent rotation of the cam directly e.g., by a power actuator) such that abutment 22b now rests on lobe 33 allowing operation of the outside release lever 40 to unlatch the latch mechanism as described above. Furthermore abutment 21b remains in contact with lobe 31 thus ensuring that operation of the inside release lever also unlatches the door mechanism.

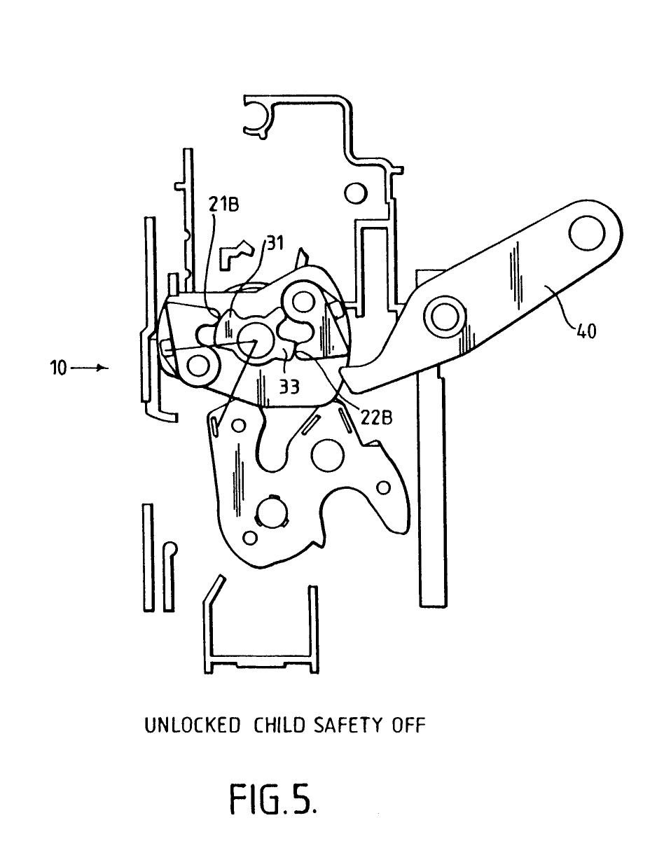

FIG. 6 shows the door latch mechanism 10 in a released position. This is achieved by rotation of cam 30 in an anticlockwise direction which allows contact between corresponding lost motion abutments (not shown) on the pawl lifter 20 and cam 30. Such lost motion abutments allow the cam 30 to rotate the pawl lifter 20 to release the door latch mechanism independently of the operation of the outside release lever 40 or the inside release lever 43.

Note that only a single cam is required to effect the various modes of operation.

In further embodiments the inside and outside lock links can be mounted directly on the pawl.

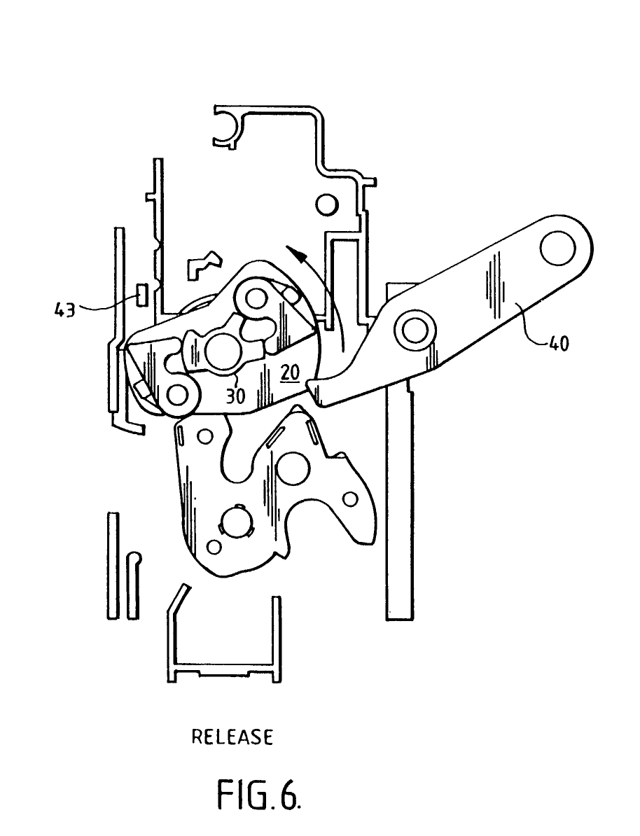

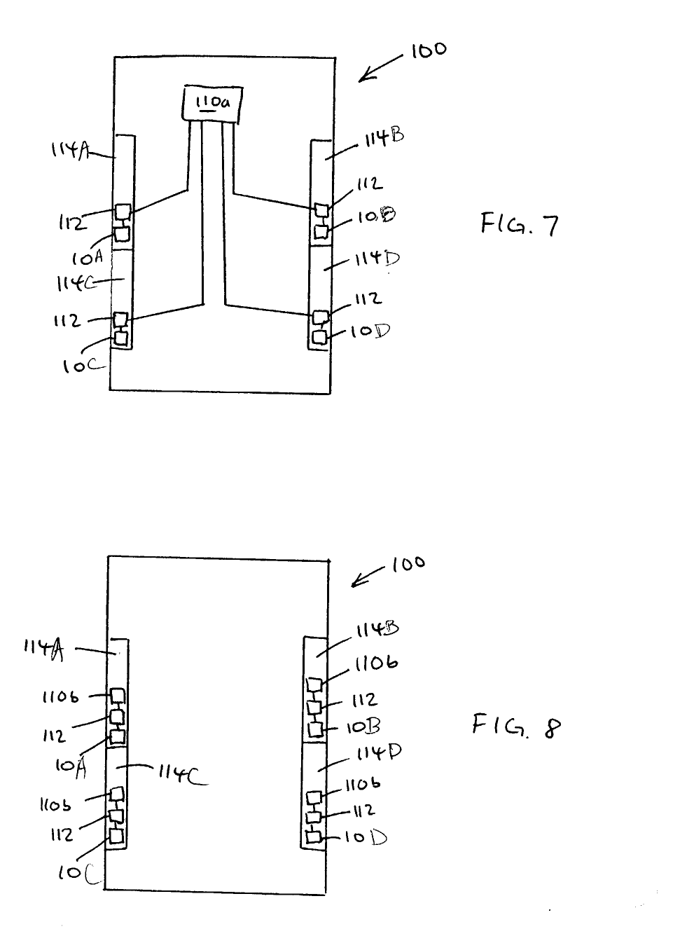

Referring to FIGS. 7 and 8 latch mechanisms 10A, 10B, 10C and 10D are shown fitted to doors 114A, 114B, 114C and 114D, respectively, of a vehicle 100. Latch mechanism 10A, 10B, 10C and 10D are all constructed like latch mechanism 10. 10A, however, is a mirror image of 10B because they are on opposite facing doors with opposing facing inside and outside release levers. 10C and 10D are also mirror images of each other. Latch mechanisms 10A, 10B, 10C and 10D may be controlled either by an integral controller (FIG. 8, 110b) or an external controller (FIG. 7,110a) so that one or more of the aforementioned modes of operation are bypassed. This is achieved by the controller 110a, 110b signalling the power actuator 112 to drive the cam 30 so that one or more lobes 31, 32 or 33 pass straight past lock links 21 and 22, meaning that this mode never appears to be available to a vehicle user. Power actuator 112 is preferably a stepper motor that may be controlled by controller 110a or 110b to rotate past the particular mode.

For example, it may be undesirable to have a child safety mode for front doors 114A and 114B but desirable to have a child safety mode for rear doors 114C and 114D. Rather than use a different latch mechanism for 114A and 114C or 114B and 114D, the same or substantially the same latch mechanism may be employed by programming controllers 110a or 110b to disable the child safety mode for front door latch mechanisms 10A and 110B but not to disable this mode for latch mechanisms 10C and 10D of rear doors 114C and 114D. Thus, controllers 110a or 110b would be programmed to control power actuators 112 to dial the cams of 10A and 10B to avoid child safety mode.

This feature may be used to enable a latch mechanism having a child safety mode to be fitted on the front door of a vehicle where child safety is not required, and/or to enable latches having a superlocking mode to be fitted to vehicles for sale in territories (e.g. the USA) which traditionally do not have vehicles supplied with a superlocking mode.

It will be appreciated that the number of operating modes available to end users for a particular latch mechanism may be set prior to fitting the latch mechanism to a vehicle, or after the vehicle is assembled. In certain variants, the latch mechanism may be re-programmable after fitting either by service personnel or vehicle users.

It will further be appreciated that by being able to manufacture a single latch mechanism which may be used in a variety of differing vehicle doors and sale territories, significant cost savings in the manufacture and supply of the mechanism may be achieved.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

We claim:

1. An assembly comprising a latch mechanism operably connected to a controller, the latch mechanism having first and second operating modes with each mode having alternate states, the controller being programmed such that said second operating mode is disabled.

2. An assembly according to claim 1, wherein said second operating mode is a child safety mode.

3. An assembly according to claim 1, wherein said second operating mode is a superlocking mode.

4. An assembly according to claim 1, wherein the latch mechanism is further provided with a third operating mode and the controller is programmed such that the third mode is disabled.

5. An assembly according to claim 4, wherein said second mode is a child safety mode and said third mode is a superlocking mode.

6. A method of controlling a latch having first and second operating modes with each mode having alternate states, the method comprising the step of controlling the latch such that the second operating mode is disabled.

7. A method according to claim 6, wherein said second operating mode is a child safety mode.

8. A method according to claim 6, wherein said second operating mode is a superlocking mode.

9. A method according to claim 6, wherein the mechanism is further provided with a third operating mode and the controller is programmed such that the third mode is disabled.

10. A method according to claim 9, wherein said second mode is a child safety mode and said third mode is a superlocking mode.

11. A door system comprising:
at least one door;
at least one latch mechanism securing the at least one door wherein the at least one latch mechanism comprises first and second operating modes with each mode having alternate states; and
a controller controlling the at least one latch mechanism, programmed such that at least one of the operating modes is disabled.

12. The door system of claim 11 wherein the at least one door comprises a first door and a second door with a first latch mechanism securing the first door and a second latch mechanism securing the second door.

13. The door system of claim 12 wherein the first mode is disabled for the first latch mechanism.

14. The door system of claim 12 wherein the first door is a front vehicle door and the second door is a rear vehicle door.

15. The door system of claim 14 wherein the first mode is a child safety mode.

16. The door system of claim 12 wherein the at least one controller comprises at least a first controller controlling the first latch mechanism and a second controller controlling the second latch mechanism.

17. The door system of claim 12 wherein the at least one controller comprising a controller controls both the first and second latch mechanisms.

18. The door system of claim 12 wherein the first mode is disabled for the first latch mechanism and the second latch mechanism.

19. The door system of claim 12 wherein the first mode is disabled for the first latch mechanism but not the second latch mechanism.

20. The door system of claim 12 wherein the first latch mechanism is substantially similar to the second latch mechanism.
